(19) United States
(12) Patent Application Publication
(10) Pub. No.: US 2010/0167017 A1
(43) Pub. Date: Jul. 1, 2010

(54) METHOD OF MAKING DISPLAY COMPONENT WITH CURABLE PASTE COMPOSITION

(75) Inventors: Yorinobu Takamatsu, Kanagawa Pref. (JP); Yusuke Saito, Kanagawa Pref. (JP); Akira Yoda, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/376,978

(22) PCT Filed: Jul. 12, 2007
(86) PCT No.: PCT/US07/73337

§ 371 Date: Feb. 10, 2009

Related U.S. Application Data
(60) Provisional application No. 60/824,360, filed on Sep. 1, 2006.

(51) Int. Cl. B32B 3/28; C08J 5/18; B29C 39/00; C08L 31/02

(52) U.S. Cl. 428/168; 264/331.18; 264/331.16; 524/556

(57) ABSTRACT

Methods of making a display panel component, rib precursor (i.e. curable paste) compositions, and articles comprising such cured and preferably sintered rib precursor compositions are described. The rib precursor (i.e. curable paste composition) comprises at least one curable aliphatic (meth)acryl binder having a low content of chlorine, fluorine, sulfur, and phosphorous and/or a molecular weight of at least 200 g/mole; a diluent; and inorganic particulate material. The low ionic content of the rib precursor is amenable to reducing corrosion, particularly of aluminum electrodes.

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which barrier ribs can be formed on glass substrates is by direct molding. This has involved laminating a mold onto a substrate with a glass- or ceramic-forming composition disposed therebetween. Suitable compositions are described for example in U.S. Pat. No. 6,352,763. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

Although various glass- and ceramic-forming compositions having inorganic particles dispersed in an organic binder have been described, industry would find advantage in new compositions, methods of use, and articles such as display components.

### SUMMARY OF THE INVENTION

Methods of making a display panel component, rib precursor (i.e. curable paste) compositions, and articles comprising such cured and preferably sintered rib precursor compositions are described.

The method comprises comprising providing a mold having a polymeric microstructured surface (e.g. suitable for making barrier ribs), placing a rib precursor material between the microstructured surface of the mold and an (e.g. electrode patterned) substrate, (e.g. ultraviolet light) curing the rib precursor material, and removing the mold.

In one embodiment, the rib precursor (i.e. curable paste composition) comprises at least one curable aliphatic (meth)acryl binder wherein the total content of chlorine, fluorine, bromine, sulfur, and phosphorous is less than 1.5 wt-%, a diluent, and inorganic particulate material. The diluent preferably has solubility parameter less than the solubility parameter of the binder. The low ionic content of the rib precursor is amenable to reducing corrosion, particularly of aluminum electrodes.

In preferred embodiments, the ionic gas content of the paste is preferably less than 1500 micrograms/gram of paste. The binder is preferably selected from an epoxy (meth)acrylate, a urethane (meth)acrylate, or a mixture thereof. In some embodiments, the binder consist of or comprises an aliphatic (meth)acrylate binder having at least three (meth)acrylate groups.

In another embodiment, the rib precursor comprises at least one curable aliphatic (meth)acryl binder; at least one diluent having a molecular weight of at least 200 g/mole and a solubility parameter less than the solubility parameter of the binder; and inorganic particulate material.

The mold is preferably transparent and has a haze of less than 8% after a single use. In preferred embodiments, the mold has a haze of less than 8% after the mold is reused at least 5 to 15 times.

The solubility parameter of the aliphatic (meth)acrylate binder typically ranges from 18 [MJ/m³]^{1/2} to 30 [MJ/m³]^{1/2}. In some embodiments, the diluent is preferably a polyalkylene glycol monoalkyl ether.

### BRIEF DESCRIPTION OF THE DRAWINGS

FIG. 1 is a perspective view of an illustrative flexible mold suitable for making barrier ribs.

FIG. 2A-2C is a section view, in sequence of an illustrative method of making a fine structure (e.g. barrier ribs) by use of a flexible mold.

### DETAILED DESCRIPTION OF THE PREFERRED EMBODIMENTS

The present invention relates to curable compositions suitable for making glass or ceramic microstructures such as barrier ribs, methods of making microstructures (e.g. barrier ribs), as well as (e.g. display) components and articles having microstructures. Hereinafter, the embodiments of the invention will be explained with reference to method of making barrier rib microstructures with a (e.g. flexible) polymeric mold. The curable compositions can be utilized with other (e.g. microstructured) devices and articles such as for example, electrophoresis plates with capillary channels and lighting applications. In particular, devices and articles that can utilize molded glass- or ceramic-microstructures can be formed using the methods described herein. While the present invention is not so limited, an appreciation of various aspects of the invention will be gained through a discussion of methods, apparatus and articles for the manufacture of barrier ribs for PDPs.

The recitation of numerical ranges by endpoints includes all numbers subsumed within the range (e.g. the range 1 to 10 includes 1, 1.5, 3.33, and 10).

Unless otherwise indicated, all numbers expressing quantities of ingredients, measurements of properties, and so like as used in the specification and claims are to be understood to be modified in all instances by the term “about.”

(“Meth)acryl” refers to functional groups including acrylates, methacrylates, acrylamide, and methacrylamide.

“(Meth)acrylate” refers to both acrylate and methacrylate compounds.

The curable rib precursor (also referred to as “slurry” or “paste”) comprises at least three components. The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening. The rib precursor composition preferably has a viscosity of less than 20,000 cps and more preferably less than 10,000 cps to uniformly fill all the microstructured groove portions of the flexible mold without entrapping air. The rib precursor composition preferably has a viscosity of between about 20 to 600 Pa-S at a shear rate of 0.1/sec and between 1 to 20 Pa-S at a shear rate of 100/sec.

Various curable organic binders can be employed. The curable organic binder is curable for example by exposure to radiation or heat. The binder may comprise monomers and oligomers in any combination, so long as the mixture with inorganic particulate material has a suitable viscosity. It is typically preferred that the binder is radiation curable under isothermal conditions (i.e. no change in temperature). This reduces the risk of shifting or expansion due to differential thermal expansion characteristics of the mold and the substrate, so that precise placement and alignment of the mold can be maintained as the rib precursor is hardened.

It has been found that certain paste compositions can liberate corrosive gas during sintering. The liberated gas can corrode (e.g. aluminum) electrodes or other (e.g.) metal components that may come in contact with the corrosive gas during sintering. Presently described are (i.e. curable paste) rib precursor compositions that comprise a curable aliphatic (meth)acryl binder having a low content of chlorine, fluorine, bromine, sulfur, and phosphorus. It has been found that the content of these elements in the binder can be a major contributor to the overall content of these elements in the paste. The content of such elements in the binder or the paste can be determined by known methods, such as the method described in the examples. This can be accomplished for example by heating the uncured binder or cured paste to generate gas, absorbing the gas in a basic aqueous solution to convert the gas components to ionic components, and measuring the concentration of such ionic components by ion chromatography. It has been found that non-corrosive paste compositions can be prepared from binders that do not comprise appreciable amounts of chlorine, fluorine, bromine, sulfur, and phosphorous. The binders described herein comprises less than 7 wt-%, 6 wt-%, 5 wt-%, 4 wt-%, 3-wt, or 2 wt-% of such ionic components. In the embodiments described herein, the aliphatic (meth)acryl binders typically comprise less than 1.5 wt-% of such ionic components (e.g. about 0.10 wt-% to about 0.50 wt-% to 1.00 wt-%).

Since the (meth)acryl binder is typically the major contributor of corrosive components, selection of an aliphatic (meth)acryl binder having a low content can ensure that the paste also has a low concentration of such corrosive components. The concentration of chlorine, fluorine, bromine, sulfur, and phosphorous is less 7,000 micrograms/gram (i.e. less than 0.73 wt-%), 6,000 micrograms/gram, 5,000 micrograms/gram, 4,000 micrograms/gram, 3,000 micrograms/gram, or 2,000 micrograms/gram. In preferred embodiments, the paste has a total concentration of chlorine, fluorine, bromine, sulfur, and phosphorous of less than 1,500 microgram/gram.

By employing a paste composition having a sufficiently low concentration of corrosive components, the electrode or other metal components that contact the paste are substantially free or corrosion (e.g. after sintering). Substantially free of corrosion refers to “No corrosion” or “Slight corrosion” according to the test method described in the examples.

Various commercially available aliphatic (meth)acryl binders may be employed such as those binder materials having a low concentration of corrosive components that are employed in the forthcoming examples. Aliphatic epoxy (meth)acrylate and urethane (meth)acrylate binder materials tend to be preferred. The aliphatic (meth)acryl binders are typically at least difunctional. In some embodiments it is preferred to employ at least 5 wt-%, 10 wt-%, 15 wt-% or 20 wt-% of an aliphatic binder that is at least trifunctional (e,g, tetrafucntional, hexafunctional) in combination with a difunctional binder. In other embodiments, the binder may consist solely of an aliphatic (meth)acryl binder that is at least trifunctional.

The diluent is not simply a solvent compound for the resin. The diluent is preferably soluble enough to be incorporated into the resin mixture in the uncured state. Upon curing of the binder of the slurry, the diluent should phase separate from the monomers and/or oligomers participating in the cross-linking process. Preferably, the diluent phase separates to form discrete pockets of liquid material in a continuous matrix of cured resin, with the cured resin binding the particles of the glass frit or ceramic powder of the slurry. In this way, the physical integrity of the cured green state microstructures is not greatly compromised even when appreciably high levels of diluent are used (i.e., greater than about a 1:3 diluent to resin ratio). This provides two advantages. First, by remaining a liquid when the binder is hardened, the diluent reduces the risk of the cured binder material adhering to the mold. Second, by remaining a liquid when the binder is hardened, the diluent phase separates from the binder material, thereby forming an interpenetrating network of small pockets, or droplets, of diluent dispersed throughout the cured binder matrix which facilitates the debinding process.

Photocurable rib precursor compositions further comprise one or more photoinitiators at a concentrations ranging from 0.01 wt-% to 1.0 wt-% of the polymerizable resin composition. Suitable photoinitiators include for example, 2-hydroxy-2-methyl-1-phenylpropane-1-one; 1-[4-(2-hydroxyethoxy)-phenyl]-2-hydroxy-2-methyl-1-propane-1-one; 2,2-dimethoxy-1,2-diphenylethane-1-one; 2-benzyl-2-dimethylamino-1-(4-morpholinophenyl)-1-butanone such as available from Ciba Specialty Chemicals under the trade designation “Irgacure 369”; 2-methyl-1-[4-(methylthio)phenyl]-2-morpholino-1-propanone such as available from Ciba Specialty Chemicals under the trade designation “Irgacure 907” in combination with a 2,4-diethylthioxanthon sensitive such as available from Nippon Kayaku Co., Ltd. under the trade designation “Kayacure DETX-S”; bis(2,4,6-trimethylbenzoyl)-phenylphosphine-oxide such as available from Ciba Specialty Chemical under the trade designation “Irgacure 819”; 2,4,6-trimethylbenzoyl-diphenylphosphine-oxide such as available from Ciba Specialty Chemical under the trade designation “Lucirin TPO”; camphorquinone in combination with a 2-wthyl4-(dimethylamino)benzoate sensitive such as available from Nippon Kayaku Co., Ltd.) under the trade designation “Kayacure EPA”; and suitable mixtures thereof. For improved shelf life with some (e.g. glass) particulate matter containing heavy metals, the paste is preferably free of photoinitiators that comprise phosphine-oxide. Suitable photoinitiators include 2-benzyl-2-N,N-dimethylamino-1-(4-morpholinophenyl)-1-butanone; thioxanthone photoinitiators such as 2,4-diethylthioxanthone; and camphorquinone.

Optionally, the photocurable rib precursor compositions may comprise a dispersant and/or a thixotropic agent. Each of these additives may be employed in amounts from about 0.05 to 2.0 wt-% of the total rib precursor composition. Typically, the amount of each of these additives is no greater than about 0.5 wt-%. Further, the rib precursor may comprise an adhesion promoter such as a silane coupling agent to promote adhesion to the substrate (e.g. glass panel of PDP). The rib precursor may also optionally comprise various additives including but not limited to surfactants, catalysts, etc. as known in the art.

In general, inorganic thixotropes may comprise clays (e.g. bentonite), silica, mica, smectite and others, having particles sizes of less than 0.1 μm. In general, organic thixotropes may comprise fatty acids, fatty acid amines, hydrogenated castor oil, casin, glue, gelatin, gluten, soybean protein, ammonium alginate, potassium alginate, sodium alginate, gum arabic, guar gum, soybean lecithin, pectin acid, starch, agar, polyacrylic acid ammonium, sodium polyacrylate, ammonium polymethacrylate, potassium salt, (e.g. modified acrylic polymers and copolymers, polyhydroxycarboxylic acid amines and amides (such as available from BYK-Chemie Co. under the trade designation “BYK 405”), polyvinyl alcohol, vinyl polymer (vinyl methyl ether/maleic anhydride), vinyl pyrrolidone copolymer, polyacrylamide, fatty acid amide or other aliphatic amide compound, carboxylated methylcellulose, hydroxymethycellulose, hydroxyethylcellulose, xanthic acid cellulose, carboxylated starch, urea urethane, oleic acid, and sodium silicate.

In some aspects, the dispersant is a basic polymer, i.e. a homopolymer, oligomer, or copolymer of at least one moderately to strongly polar Lewis base-functional copolymerizable monomer. Polarity (e.g. hydrogen or ionic bonding ability) is frequently described by the use of terms such as “strongly”, “moderately” and, “poorly”. References describing these and other solubility terms include “Solvents paint testing manual”, 3rd ea., G. G. Seward, Ed., American Society for Testing and Materials, Philadelphia, Pa., and “A three-dimensional approach to solubility”, Journal of Paint Technology, Vol. 38, No. 496, pp. 269-280. Various basic polymer dispersants are known such as an anionic polyamide based polymeric dispersant commercially available from Ajinomoto-Fine-Techno Co. under the trade designation “Ajisper PB 821”.

In other embodiments, an acidic polymer may be employed as a dispersant. For example, the rib precursor may comprise 0.1 to 1 parts by weight of a phosphorus-based compound having at least one phosphorus-acid group alone or in combination with 0.1 to 1 parts by weight of a sulfonates based compound. Such compounds are described in WO2005/019934. Other acidic polymer for use as dispersants are commercially available such as from Noveon under the trade designation “So1Plus D520”.

The amount of curable organic binder in the rib precursor composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

The paste can be prepared by conventional mixing techniques. For example, the glass- or ceramic-forming particulate material (e.g. powder) can be combined with diluent and dispersant at a ratio of about 10 to 15 parts by weight of diluent; followed by the addition of the remainder of the paste ingredients. The paste is typically filtered to 5 microns.

In preferred embodiments, the flexible mold can be reused. The number of times the flexible mold can be reused relates to the rib precursor composition employed in the method for making the microstructures. By proper selection of the rib precursor composition as described herein, the flexible mold can be reused any number of times ranging from at least one reuse to at least 5 reuses. In preferred embodiments the polymeric transfer mold can be reused at least 10 times, at least 15 times, at least 20 times, or at least 30 times. The transfer mold can be reused when the extent of swelling of the microstructured surface of the flexible mold is less than 10% and more typically less than 5%, as can be determined by visual inspection with a microscope.

In order to insure that the extent of swelling (i.e. dimensional change) of the mold is less than 10%, it has been found preferred to select a diluent having a molecular weight of at least 200 g/mole. To insure compatibility with the binder and that the resulting mixture has a suitably low viscosity, the molecular weight of the diluent is typically no greater than about 1000 g/mole. In some embodiments, the molecular weight of the diluent ranges from about 220 g/mole to about 360 g/mole.

For embodiments wherein the rib precursor is cured through the flexible mold, the flexible mold is suitable for reuse when the flexible mold is sufficiently transparent. A sufficiently transparent flexible mold typically has a haze (as measured according to the test method described in the examples) of less than 15%, preferably of less than 10% and more preferably no greater than 5% after a single use. Even more preferably, the flexible mold has the haze criteria just described after being reused at least 5 times.

In preferred embodiments, the rib precursor comprises a diluent having a solubility parameter that is less than the curable organic binder.

The solubility parameter of various monomers, S(delta), can conveniently be calculated using the expression:

δ=(ΔEv/V)^{1/2},

where ΔEv is the energy of vaporization at a given temperature and V is the corresponding molar volume. According to Fedors' method, the SP can be calculated with the chemical structure (R. F. Fedors, Polym. Eng. Sci., 14(2), p. 147, 1974, Polymer Handbook 4^{th} Edition “Solubility Parameter Values” edited by J. Brandrup, E. H. Immergut and E. A. Grulke).

The solubility parameter of various monomeric diluents can be calculated. Various illustrative (meth)acrylate monomers, the molecular weight (Mw) thereof, as well as the solubility parameter thereof are reported in the examples. Various combinations of such monomers can be employed as would be apparent by one of ordinary skill in the art.

When the solubility parameter is less 19.0 [MJ/m³]^{1/2}, the diluent can swell the (e.g. silicone rubber based) transfer mold. However, when the diluent has a solubility parameter of greater than 30.0 [MJ/m³]^{1/2} the diluent generally has poor solubility with the (e.g. urethane (meth)acrylate) oligomer.

The difference between the solubility parameter of the curable binder and the diluent is at least 1 [MJ/m³]^{1/2} and typically at least 2 [MJ/m³]^{1/2}. The difference between the solubility parameter of the curable binder and the diluent is preferably at least 3 [MJ/m³]^{1/2}, 4 [MJ/m³]^{1/2}, or 5 [MJ/m³]^{/2}. The difference between the solubility parameter of the curable binder and the diluent is more preferably at least 6 [MJ/m³]^{1/2}, 6 [MJ/m³]^{1/2}, or 8 [MJ/m³]^{1/2}.

In some embodiments, a diluent having a solubility parameter of about 19 [MJ/m³]^{1/2} is employed in combination with (meth)acrylate oligomer(s) having a solubility parameter of about 25 to 26 [MJ/m³]^{1/2}.

Various organic diluents can be employed depending on the choice of curable organic binder. In general suitable diluents include various alcohols and glycols such as alkylene glycol (e.g. ethylene glycol, propylene glycol, tripropylene glycol), alkyl diol (e.g. 1,3 butanediol,), and alkoxy alcohol (e.g. 2-hexyloxyethanol, 2-(2-hexyloxy)ethanol, 2-ethylhexyloxyethanol); ethers such as dialkylene glycol alkyl ethers (e.g. diethylene glycol monoethyl ether, dipropylene glycol monopropyl ether, tripropylene glycol monomethyl ether); esters such as lactates and acetates and in particular dialkyl glycol alkyl ether acetates (e.g. diethylene glycol monoethyl ether acetate); alkyl succinate (e.g. diethyl succinate), alkyl glutarate (e.g. diethyle glutarate), and alkyl adipate (e.g. diethyl adipate).

In some embodiments, alkylene glycol monoalkylethers and in particular polyalkylene monoalkylethers are preferred diluents. Suitable polyalkylene monoalkylethers include for example tripropyleneglycol monobutyl ether (Mw=248 g,/mole, SP=19) and polypropyleneglycol monobutyl ether (Mw=340, SP=19).

The glass- or ceramic-forming particulate material (e.g. powder) is chosen based on the end application of the microstructures and the properties of the substrate to which the microstructures will be adhered. One consideration is the coefficient of thermal expansion (CTE) of the substrate material (e.g. glass panel of PDP). Preferably, the CTE of the glass- or ceramic-forming material of the slurry of the present invention differs from the CTE of the substrate material (e.g. electrode patterned glass panel of a PDP) by no more than 10%. When the substrate material has a CTE which is much less than or much greater than the CTE of the ceramic material of the microstructures, the microstructures can warp, crack, fracture, shift position, or completely break off from the substrate during processing. Further, the substrate can warp due to a high difference in CTE between the substrate and the fired microstructures. Inorganic particulate materials suitable for use in the slurry of the present invention preferably have coefficients of thermal expansion of about 5×10⁻⁶/° C. to 13×10⁻⁶/° C.

Glass and/or ceramic materials suitable for use in the slurry of the present invention typically have softening temperatures below about 600° C., and usually above 400° C. The softening temperature of the ceramic powder indicates a temperature that must be attained to fuse or sinter the material of the powder. The substrate generally has a softening temperature that is higher than that of the ceramic material of the rib precursor. Choosing a glass and/or ceramic powder having a low softening temperature allows the use of a substrate also having a relatively low softening temperature.

Suitable composition include for example i) ZnO and B₂O₃; ii) BaO and B₂O₃; iii) ZnO, BaO, and B₂O₃; iv) La₂O₃ and B₂O₃; and v) Al₂O₃, ZnO, and P₂O₅. Lower softening temperature ceramic materials can be obtained by incorporating certain amounts of lead, bismuth, or phosphorous into the material. Other low softening temperature ceramic materials are known in the art. Other fully soluble, insoluble, or partially soluble components can be incorporated into the ceramic material of the slurry to attain or modify various properties.

The preferred size of the particulate glass- or ceramic-forming material of the rib precursor depends on the size of the microstructures to be formed and aligned on the patterned substrate. The average size, or diameter, of the particles is typically no larger than about 10% to 15% the size of the smallest characteristic dimension of interest of the microstructures to be formed and aligned. For example, the average particle size for PDP barrier ribs is typically no larger than about 2 or 3 microns.

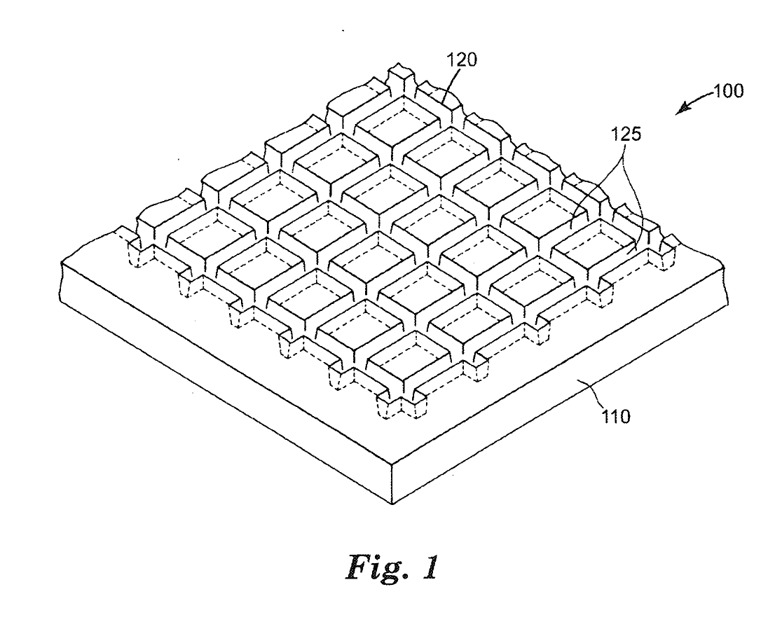

FIG. 1 is a partial perspective view showing an illustrative (e.g. flexible) mold 100. The flexible mold 100 generally has a two-layered structure having a planar support layer 110 and a microstructured surface, referred to herein as a shape-imparting layer 120 provided on the support. The flexible mold 100 of FIG. 1 is suitable for producing a grid-like rib pattern (also referred to as a lattice pattern) of barrier ribs on a (e.g. electrode patterned) back panel of a plasma display panel. Another common barrier ribs pattern (not shown) comprises plurality of (non-intersecting) ribs arranged in parallel with each other, also referred to as a linear pattern.

Although the support 110 may optionally comprise the same material as the shape-imparting layer for example by coating the polymerizable composition onto the transfer mold in an amount in excess of the amount needed to only fill the recesses, the support is typically a preformed polymeric film. The thickness of the polymeric support film is typically at least 0.025 millimeters, and typically at least 0.075 millimeters. Further the thickness of the polymeric support film is generally less than 0.5 millimeters and typically less than 0.300 millimeters. The tensile strength of the polymeric support film is generally at least about 5 kg/mm² and typically at least about 10 kg/mm². The polymeric support film typically has a glass transition temperature (Tg) of about 60° C. to about 200° C. Various materials can be used for the support of the flexible mold including cellulose acetate butyrate, cellulose acetate propionate, polyether sulfone, polymethyl methacrylate, polyurethane, polyester, and polyvinyl chloride. The surface of the support may be treated to promote adhesion to the polymerizable resin composition. Examples of suitable polyester based materials include photograde polyethylene terephthalate and polyethylene terephthalate (PET) having a surface that is formed according to the method described in U.S. Pat. No. 4,340,276.

The depth, pitch and width of the microstructures of the shape-imparting layer can vary depending on the desired finished article. The depth of the microstructured (e.g. groove) pattern 125 (corresponding to the barrier rib height) is generally at least 100 μm and typically at least 150 μm. Further, the depth is typically no greater than 500 μm and typically less than 300 μm. The pitch of the microstructured (e.g. groove) pattern may be different in the longitudinal direction in comparison to the transverse direction. The pitch is generally at least 100 μm and typically at least 200 μm. The pitch is typically no greater than 600 μm and typically less than 400 μm. The width of the microstructured (e.g. groove) pattern 4 may be different between the upper surface and the lower surface, particularly when the barrier ribs thus formed are tapered. The width is generally at least 10 μm, and typically at least 50 μm. Further, the width is generally no greater than 100 μm and typically less than 80 μm. For lattice pattern embodiments, the width of the grooves may be different in the longitudinal and transverse directions.

The thickness of an illustrative shape-imparting layer is generally at least 5 μm, typically at least 10 μm, and more typically at least 50 μm. Further, the thickness of the shape-imparting layer is generally no greater than 1,000 μm, typically less than 800 μm and more typically less than 700 μm. When the thickness of the shape-imparting layer is below 5 μm, the desired rib height for many PDP panels cannot be obtained. However, such thicknesses may be acceptable for making other types of microstructures. When the thickness of the shape-imparting layer is greater than 1,000 μm, warp and reduction of dimensional accuracy of the mold can result due to excessive shrinkage.

The flexible mold is typically prepared from a transfer mold, having a corresponding inverse microstructured surface pattern as the flexible mold. The transfer mold may have a microstructured surface comprised of a cured (e.g. silicone rubber) polymeric material, such as described in U.S. Patent Publication No. 2005/0206034.

Flexible mold 100, can be used to produce barrier ribs on a substrate for a (e.g. plasma) display panel. Prior to use, the flexible mold or components thereof may be conditioned in a humidity and temperature controlled chamber (e.g. 22° C./55% relative humidity) to minimize the occurrence of dimensional changes during use. Such conditioning of the flexible mold is described in further detail in WO2004/010452; WO2004/043664 and JP Application No. 2004-108999, filed Apr. 1, 2004.

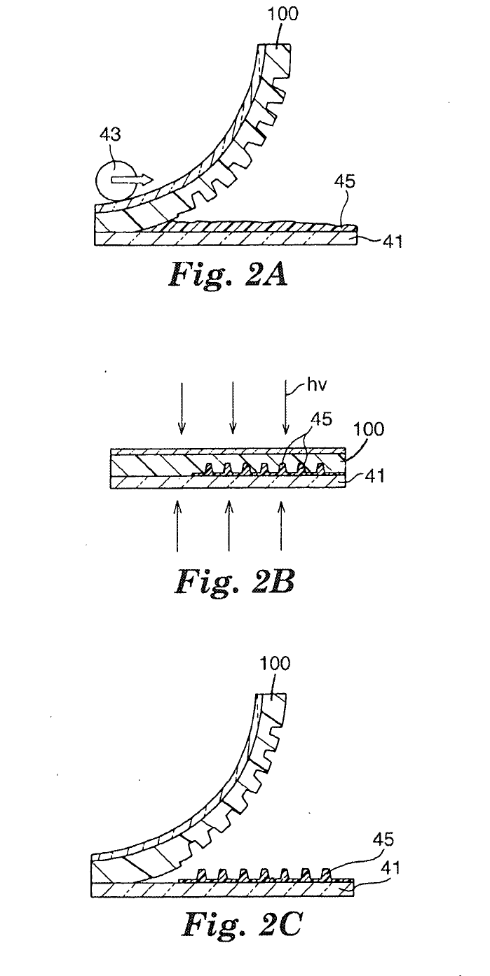

With reference to FIG. 2A, a flat transparent (e.g. glass) substrate 41, having an (e.g. striped) electrode pattern is provided. The flexible mold 100 of the invention is positioned for example by use of a sensor such as a charge coupled device camera, such that the barrier pattern of the mold is aligned with the electrode pattern of the substrate. A barrier rib precursor 45 such as a curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. As depicted in FIG. 2A, a (e.g. rubber) roller 43 may be employed to engage the flexible mold 100 with the barrier rib precursor. The rib precursor 45 spreads between the glass substrate 41 and the shape-imparting surface of the mold 100 filling the groove portions of the mold. In other words, the rib precursor 45 sequentially replaces air of the groove portions. Subsequently, the rib precursor is cured. The rib precursor is preferably cured by radiation exposure to (e.g. UV) light rays through the transparent substrate 41 and/or through the mold 100 as depicted on FIG. 2B. As shown in FIG. 2C, the flexible mold 100 is removed while the resulting cured ribs 48 remain bonded to the substrate 41.

The flexible mold preferably comprises a polymeric microstructured surface that is susceptible to damage by exposure to the curable rib precursor. Although the flexible mold may comprise other (e.g. cured) polymeric materials, at least the microstructured surface of the flexible mold typically comprises the reaction product of a polymerizable composition generally comprising at least one ethylenically unsaturated oligomer and at least one ethylenically unsaturated diluent. The ethylenically unsaturated diluent is copolymerizable with the ethylenically unsaturated oligomer. The oligomer generally has a weight average molecular weight (Mw) as determined by Gel Permeation Chromatography (described in greater detail in the example) of at least 1,000 g/mole and typically less than 50,000 g/mole. The ethylenically unsaturated diluent generally has a Mw of less than 1,000 g/mole and more typically less than 800 g/mole.

The polymerizable composition of the flexible mold is preferably radiation curable. “Radiation curable” refers to functionality directly or indirectly pendant from a monomer, oligomer, or polymer backbone (as the case may be) that react (e.g. crosslink) upon exposure to a suitable source of curing energy. Representative examples of radiation crosslinkable groups include epoxy groups, (meth)acrylate groups, olefinic carbon-carbon double bonds, allyloxy groups, alpha-methyl styrene groups, (meth)acrylamide groups, cyanate ester groups, vinyl ethers groups, combinations of these, and the like. Free radically polymerizable groups are preferred. Of these, (meth)acryl functionality is typical and (meth)acrylate functionality more typical. Typically at least one of the ingredients of the polymerizable composition, and most typically the oligomer, comprises at least two (meth)acryl groups.

Various known oligomers having (meth)acryl functional groups can be employed. Suitable radiation curable oligomers include (meth)acrylated urethanes (i.e., urethane (meth)acrylates), (meth)acrylated epoxies (i.e., epoxy (meth)acrylates), (meth)acrylated polyesters (i.e., polyester (meth)acrylates), (meth)acrylated (meth)acrylics, (meth)acrylated polyethers (i.e., polyether (meth)acrylates) and (meth)acrylated polyolefins. The oligomer(s) and monomer(s) preferably have a glass transition temperature (Tg) of about −80° C. to about 60° C., respectively, meaning that the homopolymers thereof have such glass transition temperatures.

The oligomer is generally combined with the monomeric diluent(s) in amounts of 5 wt-% to 90 wt-% of the total polymerizable composition of the flexible mold. Typically, the amount of oligomer is at least 20 wt-%, more typically at least 30 wt-%, and more typically at least 40 wt-%. In at least some preferred embodiments, the amount of oligomer is at least 50 wt-%, 60 wt-%, 70 wt-%, or 80 wt-%.

Various (meth)acryl monomers are known including for example aromatic (meth)acrylates including phenoxyethylacrylate, phenoxyethyl polyethylene glycol acrylate, nonylphenoxy polyethylene glycol, 3-hydroxyl-3-phenoxypropyl acrylate and (meth)acrylates of ethylene oxide modified bisphenol; hydroxyalkyl (meth)acrylates such as 4-hydroxybutylacrylate; alkylene glycol (meth)acrylates and alkoxy alkylene glycol (meth)acrylates such as methoxy polyethylene glycol monoacrylate and polypropylene glycol diacrylate; polycaprolactone (meth)acrylates; alkyl carbitol (meth)acrylates such as ethylcarbitol acrylate and 2-ethylhexylcarbitol acrylate; as well as various multifunctional (meth)acryl monomers including 2-butyl-2-ethyl-1,3-propanediol diacrylate and trimethylolpropane tri(meth)acrylate.

In some embodiments, the polymerizable composition of the flexible mold may comprise one or more urethane (meth)acrylate oligomers such as commercially available from Daicel-UCB Co., Ltd. under the trade designation “EB 270” and “EB 8402”. In other embodiments, the polymerizable composition of the flexible mold may comprise one or more polyolefin (meth)acrylate oligomers such as commercially available from Osaka Organic Chemical Industry Ltd., under the trade designation “SPDBA”. Other suitable flexible mold compositions are known. Preferred flexible mold compositions are described in pending U.S. Patent Publication No. 2006/0231728.

Various other aspects that may be utilized in the invention described herein are known in the art including, but not limited to each of the following patents: U.S. Patent No. 6,247,986; U.S. Pat. No. 6,537,645; U.S. Pat. No. 6,352,763; U.S. Pat. No. 6,843,952, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; WO2005/042427; WO2005/019934; WO2005/021260; and WO2005/013308.

The present invention is illustrated by the following non-limiting examples.

### Test Methods

### Measurement of Ionic Gas Concentrations

About 0.05-0.1 g of each uncured binder or cured paste sample were weighed on quartz boat and the generated gas by heating from 25° C. to 900° C. at 10° C./min under Ar/O₂ gas flow in furnace (QF-02 manufactured by Mitsubishi Chemical Corporation) was absorbed into pure water (about 18.2MΩ-cm) and 0.5 wt % hydrogen peroxide. The concentration of ionic components, chlorine (Cl⁻), fluorine (F⁻), bromine (Br⁻), sulfate ion (SO₄²⁻) and phosphate ion (PO₄³⁻) in the solution were measured with Ion Chromatograph (DX-100 manufactured by Dionex Corporation using a column manufactured by Showa Denko K. K. under the trade designation “Shodex™ SI-90-4E+SI-90G”.

The chloride content of each binder and paste tested is reported in the forthcoming tables. Unless noted other wise, the binders tested did not comprise appreciable amounts of fluoride (F⁻), bromide (Br⁻), sulfate ion (SO₄²⁻) or phosphate ion (P₄³⁻).

### Solubility Parameter (SP)

The SP value of the binder and diluent were calculated with the chemical structure by using Fedors' method (R. F. Fedors, Polym. Eng. Sci., 14(2), P. 147, 1974).

### Measurement of Haze

A 50 mm by 50 mm size sample of the smooth surface mold was measured in a haze meter (NDH-SENSOR) manufactured by Nippon Densyoku Industries, Co., in accordance with ISO-14782. The haze values provided in the examples are an average of 5 sample measurements.

### Preparation of Smooth Surface Test Molds

Since the interaction between the surface of the mold and the paste composition is the same regardless of whether the surface of the mold is microstructured, smooth surface test molds were prepared from two different UV curable compositions as follows:

### 1. Preparation of Test Mold-1

A UV-curable composition was prepared by mixing 80 parts by weight (pbw) of Ebecryl™ 8402 (urethane acrylate of polyester backbone manufactured by Daicel UCB Company Ltd.), 20 pbw of Placcel™ FA2D (ε-caprolactone modified hydroxyalkylacrylate manufactured by Daicel Chemical Industry) and 1.0 pbw of Irgacure™ 2959 (1-[4-(2-hydroxyethoxy)-phenyl]-2-hydroxy-2-methyl-1-propane-1-one photoinitiator manufactured by CIBA Specialty Chemicals). The composition was coated at a thickness of 250 microns onto a 188 micron polyester film (PET) backing and laminated to a 38 micron PET release liner. The composition was cured with 1,600 mj/cm² UV irradiated through the 188 micron PET backing with a fluorescent lamp having a peak wavelength at 352 nm (FL15BL-360 manufactured by Mitsubishi Electric Osram Ltd.). After removing the 38 micron PET release liner, Mold-1 was obtained. The haze of Mold-1 including 188 microns PET backing was 4.9+/−0.2% of haze.

### 2. Preparation of Test Mold-2

A UV-curable composition was prepared by mixing 90 pbw of Ebecryl™ 8402, 10 pbw of Placcel™, 1.0 pbw of Irgacure™ 2959 as a photoinitiator, and 0.5 pbw of BYK™-080A (manufactured by BYK-Chemie). The composition was coated at a thickness of 250 microns onto a 188 micron PET backing and laminated to a 38 micron PET release liner. The composition was cured with 3,000 mj/cm² UV irradiated through the 188 micron PET backing with the FL15BL-360 fluorescent lamp. After removing the 38 micron PET release liner, Mold-2 was obtained. The haze of Mold-2 was 6.8+/−0.2%.

### Reusability of Test Mold

The light curable pastes compositions described in the forthcoming tables were coated at a thickness of 250 microns onto a 400 mm×700 mm×2.8 mm glass substrate and laminated with the smooth surfaced test molds (i.e. Mold-1 or Mold-2) just described. The paste was cured by exposure to 0.16 mW/cm² light irradiated through the mold for 3.0 minutes with a fluorescent lamp having a peak wavelength at 400-500 nm (TLD-15W/03 manufactured by Philips). The test mold was then separated from the cured paste. This procedure was repeated (e.g. 5 or 15) times reusing the same mold and the haze of the mold was measured.

### Corrosion of Electrode During Sintering

The light curable paste compositions described in the forthcoming tables were coated at a thickness of 250 microns on 2.8 mm glass substrate which had on its surface a patterned aluminum electrode and laminated with the smooth surface test mold prepared. The paste was cured with exposure to 0.16 mW/cm² light irradiated through the mold for 3.0 minutes (2,880 mj/cm²) with a fluorescent lamp having a peak wavelength at 400-500 nm (TLD-15W/03 manufactured by Philips), and cured. The mold was then separated from the cured paste.

The obtained glass substrate was sintered at 550° C. for 1.0 hour in Electric Muffle Furnace KM-600 (30 L volume) manufactured by Advantec Co., Ltd. The amount of the paste sintered in the furnace was 50 g. All organic components in the paste were removed during the sintering process and the corrosion of the exposed electrode was observed with a microscope. The exposed electrode is that part of the electrode pattern that is not covered by the sintered paste. The corrosion was rated as “No Corrosion”, “Slight Corrosion”, meaning that corrosion was only evident at the edges on the exposed electrode pattern, or “Severe Corrosion”, meaning substantially the entire exposed electrode surface was corroded.

### Ingredients Employed in the Preparation of the Binders Compositions of Tables 1 and 3 and Paste Compositions of Tables 2, 4 and 5

Epoxy (meth)acrylate Binders

Epoxyester ™ 3000M: Dimethacrylate of Bisphenol A Diglycidyl Ether
(Kyoeisya Chemical Co., Ltd.)
Lightester ™ 3EG: Triethyleneglycol Dimethacrylate (Kyoeisya Chemical Co., Ltd.)
Epoxyester ™ 80MFA: Diacrylate of Glycerin Diglycidyl Ether (Kyoeisya Chemical Co.,
Ltd.)
Blemmer ™ GLM: Glycerin Monomethacrylate (NOF Corporation)
Aronix ™ M-315: Tris(acryloyloxyethyl) Isocyanurate (Toagosci Co., Ltd.)
Denacol Acrylate ™ DA-721: Diacrylate of Phthalic Acid Diglycidyl Ether (Nagase
Chemtex Corporation)
Lightester ™ G-201P: 2-Hydroxy-3-acryloyloxypropyl Methacrylate (Kyoeisya Chemical
Co., Ltd.)
Epoxyester ™ 3000A: Diacrylate of Bisphenol A Diglycidyl Ether (Kyoeisya Chemical
Co., Ltd.)
NK Oligo ™ EA-5321LC: Polyacrylate of Trimethylolpropane Polyglycidyl Ether
(Shin-nakamura Chemical Co., Ltd.)
NK Oligo ™ EA-5520LC: Diacrylate of 1,4-Butanediol Diglycidyl Ether (Shin-nakamura
Chemical Co., Ltd.)
NK Oligo ™ EA-5521LC: Diacrylate of 1,6-Hexanediol Diglycidyl Ether (Shin-nakamura
Chemical Co., Ltd.)
NK Oligo ™ EA-5821LC: Diacrylate of Diethyleneglycol Diglycidyl Ether (Shin-
nakamura Chemical Co., Ltd.)
NK Oligo ™ EA-5823LC: Diacrylate of Polyethyleneglycol (n = 9) Diglycidyl Ether
(Shin-nakamura Chemical Co., Ltd.)
Denacol Acrylate ™ DA-1310: Triacrylate of Ethyleneoxide modified Trimethylolpropane
Triglycidyl
Ether (Nagase Chemtex Corporation)
Denacol Acrylate ™ DA-310: Triacrylate of Glycerin Triglycidyl Ether (Nagase Chemtex
Corporation)

Urethane (meth)acrylate Binder

New Frontier ™ R-1302: Urethane Polyacrylate Oligomer containing
Isocyanurate and Biuret of Hexamethylene Diisocyanate (Dai-ichi
Kogyo Seiyaku Co., Ltd.)
Kayarad ™ UX-5000: Urethane Polyacrylate Oligomer containing
Isophorone Diisocyanate and Pentaerithritol Triacrylate (Nippon Kayaku
Co., Ltd.)
Ebecryl ™ EB270: Urethane Diacrylate Oligomer containing Polyether
Backbone (Daicel-UCB Company Ltd.)

### Diluents

PFDG: Dipropyleneglycol Monopropyl Ether (Nippon Nyukazai Co., Ltd.)
TPPG-BE: Tri(propylene glycol) Butyl Ether (DOWANOL ™ TPnB
manufactured by Dow Chemical)
PPG-BE: Polypropylene glycol monobutylether manufactured by Aldrich.

Table 1 as follows depicts the (meth)acrylate ingredients employed for use as the binder in the paste compositions of Table 2, the ratio of each ingredient in the binder, the total ionic content and chloride content of the binder, and the solubility parameter (SP) of the binder.

TABLE 1

| | | | Ionic | | |
|---|---|---|---|---|---|
| | (Meth)acrylate Binder | Ratio | Content | Chloride Content | SP |
| | Ingredient | (wt-%) | (wt-%) | (wt-%) | (MPa^{1/2}) |
| Ref. 1 | Epoxyester ™ 3000M | 70 | 0.13 | 0.13 | 24 |
| | Lightester ™ 3EG | 30 | | | |
| Ref. 2 | Epoxyester ™ 80MFA | 100 | 7.41 | 7.41 | 28 |
| Ex. 1 | New Frontier ™ R-1302 | 50 | 0.22 | 0.19 | 28 |
| | Blemmer ™ GLM | 50 | | | |
| Ex. 2 | New Frontier ™ R-1302 | 50 | 0.15 | 0.12 | 28 |
| | Blemmer ™ GLM | 30 | | | |
| | Aronix ™ M-315 | 20 | | | |
| Ex. 3 | New Frontier ™ R-1302 | 20 | 0.44 | 0.44 | 27 |
| | Denacol Acrylate ™ DA-721 | 80 | | | |
| Ex. 4 | Lightester ™ G-201P | 40 | 0.62 | 0.51 | 27 |
| | Denacol Acrylate ™ DA-721 | 60 | | | |
| Ex. 5 | Epoxyester ™ 3000A | 70 | 0.28 | 0.27 | 27 |
| | Blemmer ™ GLM | 30 | | | |
| Ex. 6 | NK Oligo ™ EA-5321LC | 100 | 0.11 | 0.11 | 26 |
| Ex. 7 | NK Oligo ™ EA-5520LC | 100 | 0.30 | 0.30 | 26 |
| Ex. 8 | NK Oligo ™ EA-5521LC | 100 | 0.22 | 0.20 | 25 |
| Ex. 9 | NK Oligo ™ EA-5821LC | 100 | 0.31 | 0.31 | 26 |
| Ex. 10 | NK Oligo ™ EA-5823LC | 100 | 0.13 | 0.13 | 23 |

Table 1 demonstrates the chloride is typically the major contributor to the total ionic content of chloride (Cl⁻), fluoride (F⁻), bromide (Br⁻), sulfate ion (SO₄²⁻) and phosphate ion (PO₄³⁻). Lightester™ G-201P was found to contain 0.28 wt-% sulfate ion.

The binder materials of Ex. 1-10 were prepared into a curable paste by combining each of the binders with diluent, photoinitiator, stabilizer and particulate inorganic material as described as follows:

| | (pbw: parts | | |
|---|---|---|---|
| Ingredients | by weight | | |
| (Meth) acrylate | 50.00 | | |
| Binder | | | |
| PFDG | 50.00 | Diluent | Dipropyleneglycol |
| | | | Monopropyl Ether |
| | | | (Nippon Nyukazai Co., |
| | | | Ltd.) |
| Lucirin ™ TPO | 1.40 | Initiator | 2,4,6-Trimethylbenzoyl- |
| | | | diphenylphosphine-oxide |
| | | | (BASF) |
| Ajisper ™ PB821 | 2.80 | Stabilizer | Stabilizer containing |
| | | | phosphoric acid |
| | | | (BYK-Chemie) |
| RFW401C2 | 416.67 | Glass Frit | Mixture of lead glass and |
| | | | inorganic oxide |
| | | | (Asahi Glass Co., Ltd.) |

The curable paste ingredients were mixed with a Conditioning Mixer AR-250 (manufactured by THINKY Corporation) at ambient temperature until homogeneous.

The ionic gas and chloride content of the paste, haze after reusing the mold 5 times, corrosion of the electrode, and rib defects were evaluated as previously described.

The results are report in Table 2 as follows:

TABLE 2

| | Paste | | | | |
|---|---|---|---|---|---|
| | | | | Sintering | |
| | | Chloride | | Performance | |
| | | Content | Reuse | Corrosion | |
| | Ionic Content | (micro | 5 times | of | Defects of |
| | microgram/g | gram/g) | (Haze %) | electrode | ribs |
| Ref. A | 690 | 59 | Mold-1 | No | No defect |
| | | | 24.9 | | |
| Ref. B | 7,300 | 7,300 | Mold-1 | Severe | No defect |
| | | | 4.9 | | |
| Ex. 1 | 760 | 130 | Mold-1 | No | No defect |
| | | | 5 | | |
| Ex. 2 | 1,180 | 80 | Mold-1 | No | No defect |
| | | | 5 | | |
| Ex. 3 | 620 | 430 | Mold-1 | Slight | No defect |
| | | | 5.4 | | |
| Ex. 4 | 350 | 350 | Mold-1 | Slight | No defect |
| | | | 6 | | |
| Ex. 5 | 150 | 150 | Mold-2 | No | A few |
| | | | 7.1 | | Crack |
| Ex. 6 | 600 | 150 | Mold-2 | No | A few |
| | | | 6.5 | | Crack |
| Ex. 7 | 170 | 170 | Mold-2 | No | No defect |
| | | | 6.4 | | |
| Ex. 8 | 290 | 290 | Mold-2 | No | A few |
| | | | 6.8 | | Crack |
| Ex. 9 | 220 | 220 | Mold-2 | No | No defect |
| | | | 7.8 | | |
| Ex. 10 | 92 | 92 | Mold-2 | No | No defect |
| | | | 6.9 | | |

Ref. 1, prepared from an aromatic di(meth)acrylate did not exhibit corrosion or rib defects, yet has a high haze value after 5 reuses. Ref. 2, prepared from an aliphatic di(meth)acrylate exhibits a low haze value and no rib defects, yet exhibited high corrosion. Example 1-10, each comprising an aliphatic (meth)acrylate binder, exhibits low haze after 5 uses in combination with good corrosion resistance and no rib defects or a few cracks. It is surmised that defects free ribs can be produced with Ex. 5, 6, and 8 by optimizing the sintering conditions.

Table 3 as follows depicts the (meth)acrylate ingredients employed for use in the binder of the paste compositions of Table 4, the number of (meth)acrylate functional groups for each binder ingredient, the ratio of each ingredient for the binder, the ionic content and chloride content of the binder, the solubility parameter (SP) of the binder, the ingredient(s) employed as the diluent, and the ratio and solubility parameter of each diluent.

TABLE 3

| | Binder | | | | | | |
|---|---|---|---|---|---|---|---|
| | Trade | Ratio | Ionic | Cl⁻ | | Diluent | |
| | Desingation | (wt- | Content | Content | SP | Ratio | SP |
| | (No. functional groups) | %) | (wt-%) | (wt-%) | (MPa^{1/2}) | (wt-%) | (MPa^{1/2}) |
| Ref. 3 | NK Oligo ™ | 100 | 0.31 | 0.31 | 26 | PFDG | 19.4 |
| | EA-5821LC | | | | | (100) | |
| | (2) | | | | | | |
| Ex. 11 | NK Oligo ™ | 100 | 0.31 | 0.31 | 26 | PFDG | 19.4 |
| | EA-5821LC | | | | | (100) | |
| | (2) | | | | | | |
| Ref. 4 | NK Oligo ™ | 100 | 0.13 | 0.13 | 23 | TPPG- | 19.0 |
| | EA-5823LC | | | | | BE | |
| | (2) | | | | | (100) | |
| Ref. 5 | NK Oligo ™ | 100 | 0.22 | 0.20 | 25 | TPPG- | 19.0 |
| | EA-5521LC | | | | | BE | |
| | (2) | | | | | (100) | |
| Ref. 6 | NK Oligo ™ | 80 | 0.18 | 0.16 | 24 | TPPG- | 19.0 |
| | EA-5521LC | | | | | BE | |
| | (2) | | | | | (100) | |
| | Ebecryl ™ | 20 | | | | | |
| | EB270 (2) | | | | | | |
| Ex. 12 | Denacol | 100 | 0.93 | 0.53 | 24 | TPPG- | 19.0 |
| | Acrylate ™ | | | | | BE | |
| | DA-1310 (3) | | | | | (100) | |
| Ex. 13 | Denacol | 100 | 0.47 | 0.47 | 27 | PFDG | 19.4 |
| | Acrylate ™ | | | | | (100) | |
| | DA-310 (3) | | | | | | |
| Ex. 14 | NK Oligo ™ | 40 | 0.37 | 0.36 | 26 | PFDG | 19.4 |
| | EA-5521LC | | | | | (100) | |
| | (2) | | | | | | |
| | Denacol | 60 | | | | | |
| | Acrylate ™ | | | | | | |
| | DA-310 (3) | | | | | | |
| Ex. 15 | NK Oligo ™ | 40 | 0.37 | 0.36 | 26 | PFDG | 19.2 |
| | EA-5521LC | | | | | (60) | |
| | (2) | | | | | | |
| | Denacol | 60 | | | | TPPG- | |
| | Acrylate ™ | | | | | BE | |
| | DA-310 (3) | | | | | (40) | |
| Ex. 16 | NK Oligo ™ | 80 | 0.25 | 0.25 | 25 | PFDG | 19.2 |
| | EA-5521LC | | | | | (40) | |
| | (2) | | | | | | |
| | Denacol | 20 | | | | TPPG- | |
| | Acrylate ™ | | | | | BE | |
| | DA-310 (3) | | | | | (60) | |
| Ex. 17 | NK Oligo ™ | 80 | 0.35 | 0.27 | 25 | TPPG- | 19.0 |
| | EA-5521LC | | | | | BE | |
| | (2) | | | | | (100) | |
| | Denacol | 20 | | | | | |
| | Acrylate ™ | | | | | | |
| | DA-1310 (3) | | | | | | |
| Ex. 18 | NK Oligo ™ | 80 | 0.18 | 0.16 | 25 | TPPG- | 19.0 |
| | EA-5521LC | | | | | BE | |
| | (2) | | | | | (100) | |
| | New | 20 | | | | | |
| | Frontier ™ R- | | | | | | |
| | 1302 (3) | | | | | | |
| Ex. 19 | NK Oligo ™ | 80 | 0.10 | 0.10 | 23 | TPPG- | 19.0 |
| | EA-5823LC | | | | | BE | |
| | (2) | | | | | (100) | |
| | Kayarad ™ | 20 | | | | | |
| | UX-5000 (6) | | | | | | |
| Ex. 20 | NK Oligo ™ | 50 | 0.17 | 0.16 | 26 | PFDG | 19.0 |
| | EA-5821LC | | | | | (100) | |
| | (2) | | | | | | |
| | New | 50 | | | | | |
| | Frontier ™ R- | | | | | | |
| | 1302 (3) | | | | | | |

Table 1 demonstrates the chlorine is typically the major contributor to the total ionic gas content of chloride (Cl⁻), fluoride (F⁻), bromide (Br⁻), sulfate ion (SO₄²⁻) and phosphate ion (PO₄³⁻). Denocaol Acrylate™ DA-1310 was found to contain 0.40 wt-% sulfate ion.

The binder and diluent materials of Table 3 were prepared into a curable paste by combining each of the binders with diluents, photoinitiator, stabilizer and particulate inorganic material as described as follows:

| | (pbw: | | |
|---|---|---|---|
| | parts by | | |
| Ingredients | weight) | | |
| (Meth)acrylate | 50.00 | | |
| Oligomer | | | |
| Diluent | 50.00 | | |
| Irgacure ™ 369 | 0.70 | Initiator | 2-Benzyl-2-dimethylamino-1-(4- |
| | | | morpholinophenyl)- |
| | | | butanone-1 (Ciba Specialty |
| | | | Chemicals) |
| Disperbyk ™ | 2.94 | Stabilizer | Stabilizer containing phosphoric |
| 111 | | | acid (BYK-Chemie) |
| RFW401C2 | 549.61 | Glass Frit | Mixture of lead glass and |
| | | | inorganic oxide |
| | | | (Asahi Glass Co., Ltd.) |

The curable paste ingredients were mixed with a Conditioning Mixer AR-250 (manufactured by THINKY Corporation) at ambient temperature until homogeneous.

The ionic content and chloride content of the paste, light exposure curing conditions, haze after reusing the mold 15 times, corrosion of the electrode, and rib defects were evaluated as previously described. The results are report in Table 4 as follows:

TABLE 4

| | Paste | | | | | |
|---|---|---|---|---|---|---|
| | | Chlorine | | | | |
| | All Ionic | Gas | Light | Reuse | | |
| | Gas Content | Content | Exposure | 15 times | Sintering Performance | |
| | (micro | (micro | Time (sec) | (Mold-2) | Corrosion of | Defects of |
| | gram/g) | gram/g) | (0.16 mW/cm2) | (Haze %) | electrode | Ribs |
| Ref. 3 | 220 | 220 | 15 sec | Bonded | No | No defect |
| | | | (240 mj/cm2) | at 5 times | | |
| Ex. 11 | 220 | 220 | 30 sec | 7.8 | No | No defect |
| | | | (480 mj/cm2) | | | |
| Ref. 4 | 92 | 92 | 15 sec | Bonded | No | No defect |
| | | | (240 mj/cm2) | at 6 times | | |
| Ref. 5 | 290 | 290 | 15 sec | Bonded | No | No defect |
| | | | (240 mj/cm2) | at 4 times | | |
| Ref. 6 | 130 | 130 | 15 sec | Bonded | No | A few Crack |
| | | | (240 mj/cm2) | at 4 times | | |
| Ex. 12 | 860 | 490 | 15 sec | 7.0 | Slight | No defect |
| | | | (240 mj/cm2) | | | |
| Ex. 13 | 440 | 440 | 15 sec | 8.3 | No | No defect |
| | | | (240 mj/cm2) | | | |
| Ex. 14 | 280 | 280 | 15 sec | 7.4 | No | A few Crack |
| | | | (240 mj/cm2) | | | |
| Ex. 15 | 280 | 280 | 15 sec | 7.4 | No | No defect |
| | | | (240 mj/cm2) | | | |
| Ex. 16 | 200 | 190 | 15 sec | 80 | No | No defect |
| | | | (240 mj/cm2) | | | |
| Ex. 17 | 270 | 270 | 15 sec | 8.3 | No | No defect |
| | | | (240 mj/cm2) | | | |
| Ex. 18 | 130 | 130 | 15 sec | 7.1 | No | A few Crack |
| | | | (240 mj/cm2) | | | |
| Ex. 19 | 80 | 80 | 15 sec | 8.0 | No | No defect |
| | | | (240 mj/cm2) | | | |
| Ex. 20 | 130 | 130 | 15 sec | 8.0 | No | No defect |
| | | | (240 mj/cm2) | | | |

Example 11-20, each comprising an aliphatic (meth)acrylate binder, exhibits low haze after 15 uses in combination with good corrosion resistance and no rib defects or a few cracks. It is surmised that defects free ribs can be produced with Ex. 14 and 18 by optimizing the sintering conditions. Ref 3 was found to remove from the mold when cured with a 30 second rather than 15 second light exposure. Ref 3-6 in comparison to Ex. 11-20 demonstrate that the reuse can be improved by the inclusion of an aliphatic (meth)acrylate binder having three or more functional groups.

### Preparation of the Mold

90 parts by weight (pbw) of Ebecryl™ 8402 (urethane acrylate of polyester backbone manufactured by Daicel UCB Company LTD.), 10 pbw of Placcel™ FA2D (1-caprolactone modified hydroxyalkylacrylate manufactured by Daicel Chemical Industry) and 1.0 pbw of Irgacure™ 2959 (1-[4-(2-hydroxyethoxy)-phenyl]-2-hydroxy-2-methyl-1-propane-1-one manufactured by CIBA Specialty Chemicals) as a photoinitiator were mixed and UV-curable monomer solution was prepared.

A rectangular, 400 mm wide×700 mm long, mold having the following lattice concave pattern was prepared by curing of the UV-curable monomer solution by 1,600 mj/cm² UV irradiation with a fluorescent lamp having a peak wavelength at 352 nm (FL15BL-360 manufactured by Mitsubishi Electric Osram LTD.).

Vertical grooves; 1,845 lines, 300 micron pitch, 210 micron height, 110 micron of groove bottom width (rib top width), 200 micron of groove top width (rib bottom width)

Lateral grooves; 608 lines, 510 micron pitch, 210 micron height, 40 micron of groove bottom width (rib top width), 200 micron of groove top width (rib bottom width)

### Viscosity of the Paste

The viscosity of the paste was measured with 4 degree 40 mm φ cone-plate of BOHLIN CVO Rheometer manufactured by Malvern with 100 sec⁻¹ rotation speed at 22 degree C.

### Examples 21-23

The paste compositions listed on Table 5 were prepared as previously described. Each paste was formed into microstructures by filling the microstructures of the mold and then contacting the filled mold with a 400 mm×700 mm×2.8 mm glass substrate. Then, 0.16 mW/cm² light was irradiated from the side of the mold for 30 seconds with a fluorescent lamp having a peak wavelength at 400-500 nm, which is manufactured by Philips, to cure the paste. The mold was then separated cleanly from the cured microstructured ceramic paste disposed on the glass substrate.

This procedure of filling the mold, curing the paste, and removing the mold was repeated 50 times using the same mold. The molds were observed visually for residual paste and the dimension change was measured with a laser microscope.

### Measurement of Dimensional Change of Mold

The dimensions of the mold were measured with a laser microscope and the average of the dimensional change (%) was calculated by the following equation.

(|(H1−H1I)/H1I|+|(B1−B1I)/B1I|+|(T1−T1I)/T1I|+|(H2−H2I)/H2I|+|(B2−B2I)/B2I|+|(T2−T2I)/T2I|)/6

wherein the initial dimensions of the mold are:
Vertical grooves: H1I (Initial height)=210 microns
B1I (Initial groove bottom width)=110 microns
T1I (Initial groove top width)=200 microns
   Lateral grooves: H2I (Initial height)=210 microns
B2I (Initial groove bottom width)=40 microns
T2I (Initial groove top width)=200 microns
   and the dimensions after reusing the same mold 50 times are:
   Vertical grooves: Height=H1 microns
Groove bottom width=B1 microns
Groove top width=T1 microns
   Lateral grooves: Height=H2 microns
Groove bottom width=B2 microns
Groove top width=T2 microns

The cured microstructured ceramic paste disposed on the glass substrates as obtained above were sintered at 550° C. for 1 hour. The organic components in the paste were burn out completely and it was formed the microstructure of glass. There was no defect on the microstructures after the sintering by a microscope observation.

TABLE 5

| Formulation (parts by weight) | | | Example 1 | Example 2 | Example 3 | Reference |
|---|---|---|---|---|---|---|
| (meth)acrylate | | SP | | | | |
| oligomer | | (MPa^{1/2}) | | | | |
| NK Oligo ™ | | 25 | 12.0 | 12.0 | | 12.0 |
| EA-5521LC | | | | | | |
| NK Oligo ™ | | 26 | | | 14.0 | |
| EA-5321LC | | | | | | |
| New Frontier ™ | | 26 | 12.0 | 12.0 | | 12.0 |
| R-1302 | | | | | | |
| Kayarad ™ | | 26 | | | 14.0 | |
| UX-5000 | | | | | | |
| | | SP | | | | |
| Diluent | Mw | (MPa^{1/2}) | | | | |
| PFDG | 176 | 19 | | | | 24.2 |
| Dowanol ™ | 248 | 19 | 24.2 | 18.2 | 28.0 | |
| TPnB | | | | | | |
| PPG-BE | 340 | 19 | | 6.0 | | |

| | | | | |
|---|---|---|---|---|
| Photoinitiator | | | | |
| Lucirin. ™ TPO | 0.6 | 0.6 | 0.6 | 0.6 |
| Dispersant | | | | |
| Disperbyk ™ 111 | 1.0 | 1.0 | | 1.0 |
| Solplus ™ D520 | | | 1.0 | |
| Ceramic powder | | | | |
| RFW401C2 | 197.0 | 197.0 | 228.9 | 197.0 |
| Viscosity (Pa-s) | 4.0 | 4.0 | 6.0 | 4.0 |

Evaluation of mold reuse-ability (50 times)

| | | | | |
|---|---|---|---|---|
| Sintering performance | No Defect | No Defect | No Defect | No Defect |
| Surface of mold | No residual | No residual | No residual | No |
| | paste | paste | paste | residual |
| | | | | paste |
| Dimension change of mold (%) | 2.0 | 1.7 | 1.1 | 12.0 |

1-14. (canceled)

15. A method of making a microstructured component comprising:
providing a mold having a polymeric microstructured surface;
placing a microstructure precursor composition between the microstructured surface of the mold and a substrate wherein the microstructure precursor comprises:
at least one curable aliphatic (meth)acryl binder having a total content of chlorine,
fluorine, bromine, sulfur, and phosphorus of less than 1.5 wt-%, and
at least one diluent, and
optionally inorganic particulate material;
curing the microstructure precursor material; and
removing the mold.

16. The method of claim 15 wherein the aliphatic (meth)acryl binder is selected from an epoxy (meth)acrylate, a urethane (meth)acrylate, and mixture thereof.

17. A curable paste composition comprising:
at least one curable aliphatic (meth)acryl binder having a solubility parameter and a total ionic content of chlorine, fluorine, bromine, sulfate, and phosphate of less than 1.5 wt-%;
at least one diluent having a solubility parameter less than the solubility parameter of the binder, and
inorganic particulate material.

18. The curable paste composition of claim 17 wherein the binder comprises a curable aliphatic (meth)acrylate binder having at least three polymerizable (meth)acrylate groups.

19. A display component comprising:
a transparent substrate and a plurality of barrier ribs disposed on the transparent substrate wherein the barrier ribs comprise the cured composition of claim 17.

20. A curable paste composition comprising:
at least one curable aliphatic (meth)acryl binder a total content of chlorine, fluorine, bromine, sulfur, and phosphorus of less than 1.5 wt-%;
at least one diluent; and
inorganic particulate material.

21. The curable paste of claim 20 wherein the aliphatic (meth)acryl binder is selected from an epoxy (meth)acrylate, a urethane (meth)acrylate, and mixture thereof.

22-30. (canceled)

31. A method of making a microstructured component comprising:
providing a mold having a polymeric microstructured surface;
placing a microstructure precursor composition between the microstructured surface of the mold and a substrate wherein the microstructure precursor comprises:
at least one curable aliphatic (meth)acryl binder having a solubility parameter;
at least one diluent having a molecular weight of at least 200 g/mole and a solubility
parameter less than the solubility parameter of the binder; and
optionally inorganic particulate material;
curing the microstructure precursor material; and
removing the mold.

32. A curable paste composition comprising:
at least one curable aliphatic (meth)acryl binder having a solubility parameter;
at least one diluent having a molecular weight of at least 200 g/mole and a solubility parameter less than the solubility parameter of the binder; and inorganic particulate material.

33. A display component comprising:
a transparent substrate and a plurality of barrier ribs disposed on a transparent substrate wherein the barrier ribs comprise the cured composition of claim 32.

34. A microstructured component comprising:
a substrate and a plurality of microstructures disposed on the substrate wherein the microstructures comprise the cured composition of claim 17.

35. A microstructured component comprising:
a substrate and a plurality of microstructures disposed on the substrate wherein the microstructures comprise the cured composition of claim 32.
